(19) United States
(12) Patent Application Publication
(10) Pub. No.: US 2005/0004257 A1
(43) Pub. Date: Jan. 6, 2005

(54) Reactive amine catalysts for use in pucb foundry binder

(76) Inventors: Michael David Gernon, Phoenixville, PA (US); Christine Marie Trumpfheller, Haddonfield, NJ (US); Bobby Allen Picker, Aurora, IL (US)

Correspondence Address: Gilbert W. Rudman;ATOFINA Chemicals, Inc., 2000 Market Street, Philadelphia, PA, 19103, US

(21) Appl. No.: 10/891,264

(22) Filed: Jul. 12, 2004

Related U.S. Application Data
(63) Continuation of application No. 10/636,428, filed on Aug. 7, 2003, now abandoned.
(60) Provisional application No. 60/410,245, filed on Sep. 12, 2002.

(51) Int. Cl. C08K 3/00; B01J 31/00

(52) U.S. Cl. 523/139; 502/162

(57) ABSTRACT

The present invention relates a reactive tertiary amine catalyst used in a phenolic urethane cold box process. Through the use of a reactive tertiary amine, the problems associated with vaporous amine waste streams can be eliminated. Some typical reactive tertiary amine catalysts that are useful in the present invention include 1-dimethylamino-2-propanol (DMA-2P), monoethanolamine and dimethylaminopropylamine (DMAPA).

### REFERENCE TO RELATED APPLICATION

This application is a continuation of Ser. no. 10/636,428 filed Aug. 7, 2003 which claims the benefit of U. S. Provisional Application Ser. No. 60/410,245, filed Sep. 12, 2002.

### BACKGROUND OF THE INVENTION

1. Field of the Invention

The present invention relates to the use of a volatile and reactive cure accelerating amine catalyst in a phenolic urethane cold box (PUCB) foundry process to fabricate resin bound sand composites while eliminating odor and waste streams resulting from the process.

2. Description of the Prior Art

Amine catalysts are used extensively for the curing of polyurethane polymers which are produced via a condensation reaction of a polyol with a polyisocyanate.

Uncured polyol and polyisocyanate resins can be mixed with sand and then cured with an amine catalyst to yield solid sand-resin composites which are useful as molds for casting molten metal.

A number of methods have been developed in order to fabricate resin bound sand composites into useful shapes. The PUCB (phenolic urethane cold box) process is one such method.

In the PUCB process, sand, polyol and polyisocyanate are first premixed and formed into a useful shape. Next, gaseous amine catalyst is passed through the preformed shape in order to cure it into a hard mass. The PUCB process is well suited for integration into high thru-put automated industrial production systems, and the PUCB process has become the dominant industrial method for producing molds and cores for metal castings.

The use of tertiary amines as cure accelerating catalysts for the Polyurethane Cold Box process is well known:

Brambila et al., 2000, U.S. Pat. No. 6,071,985; Paseo de la Reforma No. 30, “Catalytic Curing Agent for Resins and Method For Making The Same”, describes the use of DMPA (dimethylpropylamine) as a PUCB cure accelerator.

Chen et al., 1997, U.S. Pat. No. 5,688,857; Ashland, “Polyurethane Forming Cold Box Binders and their Uses”, describes different types of resin components which can be used.

Nisi et al., 1989, U.S. Pat. No. 4,886,105; “Process for Curing Sand Moldings”, describes mechanical aspects of assembling and running a PUCB process.

Giebeler, 1998, U.S. Pat. No. 5,808,159; “Process and Device for Recovering Amines and Use of Residues Obtainable Thereby”, describes methods for scrubbing tertiary amines from waste gas stream and describes methods for recycling tertiary amines within PUCB process.

Robins, 1968, U.S. Pat. No. 3,409,579; “Foundry Binder Composition Comprising Benzylic Ether Resin, Polyisocyanate, and Tertiary Amine”, describes the use of tertiary amines as cure accelerators for mixed resins containing phenolic polyols (phenol-formaldehyde resin) and MDI type polyisocyanates.

None of these references disclose the use of “reactive amine catalysts” for the PUCB process nor the use of “reactive amine catalysts” for the curing of sand-resin composites.

For the curing of polyurethane foam systems, a number of references describe the use of reactive amine catalysts. However, PU foam systems are vastly different from sand binding polyurethane systems.

For example, polyurethane foam systems consist of 5 components in addition to the amine cure catalyst; polyol, polyisocyanate, surfactant, blowing agent, specialty additives (e.g., color pigments, dyes, biocides) while sand binding polyurethane systems consist of only two components in addition to the amine cure catalyst; polyol and polyisocyanate in a naphthenic or paraffinic solvent.

Also, the polyurethane foam system is blown to a much lower density than the sand binding system and has much lower solids loading (oftentimes no solid loading at all).

Thus, the efficacy of a reactive amine catalyst in one system does not automatically imply efficacy in the other.

The prior art does not foresee the utility of reactive amine catalysts as cure accelerators in sand binding polyurethane systems which ultimately result in a PUCB process which is more economical and environmentally friendly.

### SUMMARY OF THE INVENTION

The present invention relates to the use of a reactive tertiary amine catalyst in a PUCB type foundry binder system. Through the use of a reactive tertiary amine, the problems associated with vaporous amine waste streams can be eliminated.

The current invention is practiced by simply replacing the volatile tertiary amine catalyst typically employed in a PUCB process with a reactive tertiary amine catalyst that will condense within the polyurethane binder.

The incorporation by chemical reaction of the reactive tertiary amine catalyst within the polyurethane binder eliminates waste amine in the off-gas stream which exits from the mold, and this elimination of waste amine saves money by making effluent treatment more economical.

Some typical reactive tertiary amine catalysts which are useful in the present invention include 1-dimethylamino-2-propanol (DMA-2P), monoethanolamine, dimethylaminopropylamine (DMAPA), etc.

### DETAILED DESCRIPTION OF THE INVENTION

The current invention describes a means of more efficiently and economically producing solid cores from mixtures of sand and polyurethane resin. The cores under consideration are produced by curing mixtures of sand, phenol-formaldehyde polyol resin and MDI type polyisocyanate resin with reactive tertiary amine catalysts.

The process is generically referred to as the “phenolic urethane cold box” process.

In the prior art the curing is carried out by passing the gaseous volatile tertiary amine catalyst through sand/resin mixture which has been packed into a dye, mold negative or core box. The amine catalyzes the formation of a polyurethane polymer from the mixed polyol and polyisocyanate resins, and this polyurethane polymer binds to the sand particles and creates a solid mass. These molds and solid cores may be used to directly cast metal parts, or they may be used to create void areas in molds used for casting complex shapes. These void areas end up mostly encapsulated in the final metal product, and it is usually impossible to remove the intact core from the molded piece. Thus, these cores are broken out of the finished piece. The cores must be hard enough to survive the metal casting process but fragile enough to be removed after the part has cooled and hardened. Amine cured sand with a polyurethane binder has been found to be ideal for this purpose.

Operationally, the volatile tertiary amine curing catalyst is vaporized by heating it in a sealed system. The amine vapor is passed through the sand/resin mixture with the aid of an inert carrier gas (e.g., dry air). Because the volatile tertiary amine does not permanently react with the sand/resin mixture, it mostly passes out of the core box. Thus, the amine effluent from the prior art core curing operation must be collected and waste treated, and this waste treatment adds cost to the process.

The present invention relates to the use of reactive tertiary amine catalysts, such as, 1-dimethylamino-2-propanol, dimethylaminoethanol and methyldiethanolamine in place of regular tertiary amine catalysts, such as, triethylamine (TEA), dimethylethylamine (DMEA), dimethylisopropylamine (DMIPA) and dimethylpropylamine (DMPA), wherein the reactive tertiary amine catalysts allow for the complete elimination of the amine waste stream.

To make the tertiary amine catalyst reactive, it is structurally modified to contain a reactive function (e.g., hydroxyl group) that will allow it to be incorporated into the polyurethane polymer. After the reactive tertiary amine is incorporated into the polyurethane binder, it becomes non-volatile (i.e., its vapor pressure decreases to nearly zero) and is removed from the vapor stream. By matching the reactivity of the reactive tertiary amine catalyst to the process cycle time for a given core production operation, one can insure that all of the catalyst amine which is introduced into the core box cavity is reacted with and incorporated into the sand/resin cores being produced.

The term “reactive amine catalyst” refers to a molecule which contains both a tertiary amine moiety and a remote reactive group at least 2 carbons removed from the tertiary amine group, which preferably is a reactive partially protonated heteroatom group (e.g., hydroxy, amino, etc.).

The reactive group is one that can take part in a condensation reaction (e.g., urethane formation) through addition to an isocyanate group. Generally, a reactive group that can condense with acetyl chloride to yield an acetyl derivative can also react with an isocyanate group to yield a condensation product. The condensation product can be a urethane type derivative (group VI heteroatom) or a urea type derivative (group V heteroatom). By far the most common remote reactive moiety is the hydroxyl group, but primary amino, secondary amino, and/or other partially protonated nucleophilic heteroatoms (e.g., thiols, selenols) also qualify.

The generic structure for the reactive amine catalyst is:
RR′N(CR″₂)ₘC(XHₙ)R″₂
wherein
each R,R′ is independently an alkyl group, preferably having from 1 to 3 carbon atoms,
R″ is H or an alkyl group, preferably having from 1 to 3 carbon atoms,
m is 1-12, preferably 1,
X is O, S, Se, Te, N, P or As preferably N or O, and
n is 1 for Group VI heteroatoms
n is 1 or 2 for Group V heteroatoms.

Included also are a homologated version of the above as:
RR′N{(CR″₂)ₘC(XHₙ)}_{q}(CR″₂)ₚC(XHₙ)R″₂
wherein
R′, R″, m, X & n are defined as above,
p and q are each independently 1-12,
preferably 1.

By far, the most useful class of reactive amine catalysts for the curing of polyurethane systems is the N,N-dialkylalkanolamines (RR′NCH₂CH₂OH). The tertiary amino group functions as the urethane condensation catalyst while the remote hydroxyl group allows for the catalyst to become appended to the polyurethane network as a pendant group.

Reactive amine catalysts for polyurethane condensation reactions are not true catalysts because they take part in the reaction, but the use of the term reactive catalyst has precedence within the field of polyurethane foam production. The use of reactive amine catalysts in foundry binder systems has never previously been described. The advantage of using reactive amine catalysts in PUCB foundry binder systems is derived from elimination of the waste stream of vaporous amine. By reacting with the amine catalyst inside the polyurethane matrix, one eliminates the need to collect and dispose of waste amine.

Foundry binder systems provide adhesion in the sand molds and cores used for metal casting. A commonly used foundry binder system involves a two component polyurethane pre-polymer resin containing a phenolic polyol and a methylene diisocyanate (MDI) type poly-isocyanate which is cure accelerated with a tertiary amine.

There are two methods used in the production of polyurethane bound sand molds and cores for metal castings. In the “cold box process”, a volatile amine is passed through a mixture of sand and resin in a patterned mold box in order to accelerate curing to a solid mass. The other method is the “no bake process” in which an appropriate amine catalyst is premixed with sand and resin such that there is sufficient time to pack the material into a mold before it cures. PUCB, owing to the ease with which it is incorporated into automated operations, is the most commonly used cure method in the foundry industry.

There are four stages in the cold box process. The first step (blowing) involves passing resin coated sand from a hopper into a core box with blown dry air. The second step (gassing) introduces the amine catalyst through heated pipes into a pattern cavity. The third step (purging) involves passing heated dry air through the system to flush out residual amine. In the last step (stripping), the core is removed from the pattern box.

The use of a reactive amine catalyst makes the PUCB core making process more economical by eliminating the need to collect waste from the purge stream. A reactive amine catalyst can be introduced into the system in the same manor as traditional PUCB catalysts (i.e., as a gas), but owing to reaction of the catalyst with the sand binding resin there will be no residual amine in the air purge stream. This eliminates the need to waste treat the purge stream. Also, the use of a reactive amine catalyst aids in the reduction of residual amine odor in the mold.

### EXAMPLES

### Example 1

### Demonstration of Tensile Strength

A Polyurethane Cold Box (PUCB) apparatus was constructed. The apparatus contained a heating chamber that was used to vaporize the amine. Dry nitrogen was employed as the carrier gas. The apparatus was connected to a mold cavity with an inlet and an outlet. Dry ice traps were used-to collect the amine vapors that passed out of the mold cavity. A constant flow monitor was used to insure that the carrier gas flow rate was constant. Silica sand filler mixed with 2.0% by weight of mixed isocyanate and phenolic polyol resin was prepared as follows:
To a 500 ml plastic beaker, 100 g of silica sand (Wedrond Silica Inc., washed silica sand), 1 g of phenolic resin (Sigma Cure™ 7210) and 1 g of isocyanate resin (Sigma Cure™ 7500) was added without mixing. Using a hand mixer (Hamilton Beach, Model 62698), the above sand/resin mixture was stirred until it was uniform in composition.

The sand mixture so prepared was compacted into a mold and then placed in the cavity mold portion of the PUCB apparatus. Next, 5 g of triethylamine (TEA) was injected into the heating chamber, vaporized and passed through the resin/sand block. The experiment was repeated with dimethylamino-2-propanol (DMA2P). The cured sand resin composite from each experiment was cut and shaped into a dog bone. The TEA and DMA2P dog bones were independently analyzed for ultimate (24 hour) tensile strength. The tensile testing was performed on the Miniature Materials Tester (Minimat 2000). The results were:

| | Tensile Strength, replicate 1 | Tensile Strength, replicate 2 |
|---|---|---|
| Amine | (psi) | (psi) |
| TEA | 362 | 377 |
| DMA-2P | 333 | 362 |

The same experiments were repeated with a different resin system. The following was used: 1 g of phenolic resin (Sigma Cure™ 7220) and 1 g of the isocyanate resin (Sigma Cure™ 7720). The results were:

| Test Conditions For Tensile Test | TEA | DMA-2P |
|---|---|---|
| Amount of Catalyst | 1 ml | 0.5 ml |
| Amine Vaporization Chamber Temperature, ° F. | 175 | 220 |
| 1 minute (psi) | 148 | 152 |
| 1 hour (psi) | 199 | 230 |
| 2 hours @ 100% Relative Humidity (psi) | 93 | 99 |
| 24 hours 66.6° F.-19% Relative Humidity (psi) | 230 | 248 |
| 24 Hours @ 100% Relative Humidity (psi) | 57 | 72 |

The two cure systems produced sand resin composites with approximately equal tensile strengths showing that the process of the present invention results in a product having a tensile strength similar to or better than that of the product produced by a prior art process, while the process of the present invention eliminated much of the amine waste stream and amine odor.

### Example 2

### Reduced Amine Waste

Using the same apparatus described in Example 1, we measured the amount of effluent amine that passes through a sand resin block during the amine cure process. Repeating the procedure outlined in Example 1, we obtained the following data.

TEA Trial Runs

| | | | | Amine Recover | | | | | | | | |
|---|---|---|---|---|---|---|---|---|---|---|---|---|
| | Amine | Weight | Amine | | Non- | | | Sand Mold Weight | | | | Passed |
| | Injected | Recover | Percent | Amine | Amine | Cure | Odor | Before | After | Delta | AR* | Amine* |
| Trial # | (g) | (g) | (%) | (g) | (g) | (Y/N) | (Y/N) | (g) | (g) | (g) | (%) | (%) |
| 1 | 5.00 | 1.00 | 20.00% | 0.20 | 0.80 | Y | Bad | 264.2 | 265.1 | 0.90 | 0.35 | 4.00% |
| 2 | 5.00 | 1.20 | 24.00% | 0.29 | 0.91 | Y | Bad | 249.7 | 250.2 | 0.50 | 0.30 | 5.76% |
| 3 | 5.00 | 1.50 | 30.00% | 0.45 | 1.05 | Y | Bad | 251.3 | 251.7 | 0.40 | 0.32 | 9.00% |
| 4 | 5.00 | 2.00 | 40.00% | 0.80 | 1.20 | Y | Bad | 265.3 | 266.1 | 0.80 | 0.48 | 16.00% |
| 5 | 5.00 | 2.00 | 40.00% | 0.80 | 1.20 | Y | Bad | 276.9 | 277.8 | 0.90 | 0.50 | 16.00% |
| 6 | 5.00 | 2.50 | 50.00% | 1.25 | 1.25 | Y | Bad | 275.4 | 276.1 | 0.70 | 0.52 | 25.00% |
| 7 | 5.00 | 2.50 | 50.00% | 1.25 | 1.25 | Y | Bad | 274.5 | 275.2 | 0.70 | 0.52 | 25.00% |
| 8 | 1.00 | 0.65 | 65.00% | 0.42 | 0.23 | Y | Bad | 272.6 | 273.1 | 0.50 | 1.26 | 42.25% |
| 9 | 1.00 | 0.61 | 61.00% | 0.37 | 0.24 | Y | Bad | 276.7 | 277.1 | 0.40 | 1.02 | 37.21% |
| 10 | 1.00 | 0.59 | 59.00% | 0.35 | 0.24 | Y | Bad | 274.8 | 275.1 | 0.30 | 0.83 | 34.81% |
| 11 | 1.00 | 0.55 | 55.00% | 0.30 | 0.25 | Y | Bad | 278.3 | 278.7 | 0.40 | 0.93 | 30.25% |
| 12 | 1.00 | 0.57 | 57.00% | 0.32 | 0.25 | Y | Bad | 280.2 | 280.8 | 0.60 | 1.25 | 32.49% |

DMA-2P Trial Runs

| | | | | Amine Recover | | | | | | | | |
|---|---|---|---|---|---|---|---|---|---|---|---|---|
| | Amine | Weight | Amount | | Non- | | | Sand Mold Weight | | | | Passed |
| | Injected | Recover | Percent | Amine | Amine | Cure | Odor | Before | After | Delta | AR | Amine |
| Trial # | (g) | (g) | (%) | (g) | (g) | (Y/N) | (Y/N) | (g) | (g) | (g) | (%) | (%) |
| 1 | 5.00 | 1.10 | 22.00% | 0.24 | 0.86 | Y | Slight | 268.5 | 269.1 | 0.60 | 0.31 | 4.84% |
| 2 | 5.00 | 1.30 | 26.00% | 0.34 | 0.96 | Y | Slight | 273.4 | 273.7 | 0.30 | 0.27 | 6.76% |
| 3 | 5.00 | 1.00 | 20.00% | 0.20 | 0.80 | Y | Slight | 276.5 | 277 | 0.50 | 0.27 | 4.00% |
| 4 | 5.00 | 1.20 | 24.00% | 0.29 | 0.91 | Y | Slight | 277.3 | 277.8 | 0.50 | 0.30 | 5.76% |
| 5 | 5.00 | 1.10 | 22.00% | 0.24 | 0.86 | Y | Slight | 278.2 | 278.7 | 0.50 | 0.29 | 4.84% |
| 6 | 5.00 | 1.30 | 26.00% | 0.34 | 0.96 | Y | Slight | 269.3 | 270.1 | 0.80 | 0.38 | 6.76% |
| 7 | 5.00 | 1.10 | 22.00% | 0.24 | 0.86 | Y | Slight | 272.4 | 272.9 | 0.50 | 0.29 | 4.84% |
| 8 | 1.00 | 0.21 | 21.00% | 0.04 | 0.17 | Y | Slight | 275.4 | 275.8 | 0.40 | 0.59 | 4.41% |
| 9 | 1.00 | 0.22 | 22.00% | 0.05 | 0.17 | Y | Slight | 275.3 | 275.9 | 0.60 | 0.81 | 4.84% |
| 10 | 1.00 | 0.24 | 24.00% | 0.06 | 0.18 | Y | Slight | 276.4 | 276.9 | 0.50 | 0.72 | 5.76% |
| 11 | 1.00 | 0.20 | 20.00% | 0.04 | 0.16 | Y | Slight | 277.5 | 278 | 0.50 | 0.69 | 4.00% |
| 12 | 1.00 | 0.25 | 25.00% | 0.06 | 0.19 | Y | Slight | 269.5 | 270.1 | 0.60 | 0.84 | 6.25% |

AR=Accuracy Ratio: This value gives an indication of how well we are accounting for mass balance within the system. When the AR is less than 1, mass has disappeared. A possible cause of an AR that is less than 1 is amine overloading. Amine overloading can result in excess amine traveling through the system and out the bubbler. When the AR is greater than 1, mass has been created. Excess mass in the system might result from water absorbed into the mold. We are attempting to get our AR value as close to 1 as possible. Acceptable values of AR are marked with blue text in the Table above.
Passed Amine: This value is the ratio of the weight of amine passed through the sample to the amount of amine injected.

Restricting our attention to those runs with an acceptable Accuracy Ratio value (0.68<AR<1.30), it is apparent that only 1/8 as much DMA-2P relative to TEA passes through the cured mold. By extrapolation with this data, we can state that DMA-2P as compared to TEA results in a better than 90% reduction in effluent amine waste.

1-7. (cancelled)

8. A method of forming a resin bound sand composite using a phenolic urethane cold box process wherein sand, polyol and polyisocyanate are mixed, formed into a useful shape and cured via a gaseous catalyst wherein the improvement comprises using a reactive tertiary amine compound having both a tertiary amine moiety and a reactive group at least two carbons removed from the tertiary amine moiety as the gaseous catalyst.

9. The method of claim 1 wherein the remote reactive group is a partially protonated heteroatom group.

10. The method of claim 8 wherein the reactive tertiary amine compound has the formula:
RR′N(CR″₂)ₘC(XH_{n)R″}₂
wherein
each R,R′ is independently an alkyl group,
R″ is H or an alkyl group,
m is 1-12,
X is O, S, Se, Te, N, P or As, and
n is 1 for Group VI heteroatoms
n is 1 or 2 for Group V heteroatoms,
or a homologated version thereof having the formula:
RR′N{(CR″₂)ₘC(XHₙ)}_{q}(CR″₂)ₚC(XHₙ)R″₂
wherein
R′, R″, m, X & n are defined as above,
p and q are each independently 1-12,
preferably 1.

11. The method of claim 10 wherein the reactive tertiary amine compound has the formula:
RR′N(CR″₂)ₘC(XHₙ)R″₂
wherein
each R,R′ is independently an C₁₋₃ alkyl group,
R″ is H or a C₁₋₃ alkyl group,
m is 1,
X is N or O, and
n is 1 or 2,
or a homologated version thereof having the formula:
RR′N{(CR″₂)ₘC(XHₙ)}_{q}(CR″₂)ₚC(XHₙ)R″₂
wherein
R′, R″, m, X & n are defined as above,
p and q are each 1.

12. The method of claim 11 wherein the amine is 1-dimethylamino-2-propanol, dimethylaminoethanolamine or methyldiethanolamine.

13. The method of claim 8 wherein the reactive tertiary amine can be conveniently vaporized to yield a gaseous curing agent.

14. The method of claim 1 wherein said reactive tertiary amine compound is passed through the sand, polyol and polyisocyanate mixture in an inert gas carrier.

15. The method of claim 14 wherein said inert gas carrier is dry air.
